(19) United States
(12) Patent Application Publication
(10) Pub. No.: US 2016/0350720 A1
(43) Pub. Date: Dec. 1, 2016

(54) RECOMMENDING MEETING TIMES BASED ON PREVIOUS MEETING ACCEPTANCE HISTORY

(71) Applicant: CITRIX SYSTEMS, INC., Fort Lauderdale, FL (US)

(72) Inventors: Yogesh Moorjani, Goleta, CA (US); Michael Holt, Santa Barbara, CA (US); Karthikeyan Subramaniam, Goleta, CA (US); Vito Loconte, III, Albany, CA (US); Ashish V. Thapliyal, Santa Barbara, CA (US)

(21) Appl. No.: 14/725,016

(22) Filed: May 29, 2015

(51) Int. Cl. G06Q 10/10

(52) U.S. Cl. CPC G06Q 10/1095

(57) ABSTRACT

Techniques of finding a meeting time involve recommending a meeting time based on attendee meeting history. Along these lines, a meeting scheduler accesses meeting logs that contain trends involving previous meetings to which attendees were invited. For example, such meeting logs may indicate whether an attendee accepted meeting invitations to meetings occurring at particular times during a workweek. Based on the accessed meeting logs, the meeting scheduler recommends a time at which to hold the meeting. For example, the meeting logs may indicate that an attendee declines invitations at certain times of the day, or that another attendee has flexibility during a time labeled as unavailable in the calendar. The meeting schedule then sends a message to the meeting organizer that contains the recommended time.

### BACKGROUND

Conventional calendar applications display upcoming meetings and available meeting times to their owners. If the conventional calendar applications are configured with appropriate data sharing privileges, the conventional calendar applications are further able to display upcoming meetings and available meeting times of others.

To invite people to a new meeting, a human meeting organizer views the available times of each invitee using the organizer's calendar application. The organizer then identifies a particular meeting time during which each invitee is available, and sends an electronic invite for that meeting time to the calendar application of each invitee.

### SUMMARY

Unfortunately, there are deficiencies in the above-described conventional calendar applications. For example, the conventional calendar applications do not take individual invitee preferences into account. In one case, some invitees may prefer to attend meetings in the afternoon. In another case, some invitees may be part of a team that delegates a single member to attend meetings. By not taking such preferences into account, the conventional calendar applications miss opportunities to improve the user experience.

In contrast with the above-described conventional calendar applications which do not take individual invitee preferences into account, improved techniques involve recommending a meeting time based on attendee meeting history. Along these lines, an automatic meeting scheduler accesses meeting logs that contain trends involving previous meetings to which attendees were invited. For example, such meeting logs may indicate whether an attendee accepted meeting invitations to meetings occurring at particular times during a workweek. Based on the accessed meeting logs, the meeting scheduler recommends a time at which to hold the meeting. For example, the meeting logs may indicate that an attendee declines invitations at certain times of the day, or that another attendee has flexibility during a time labeled as unavailable in the calendar. The meeting schedule then sends a message to the meeting organizer that contains the recommended time.

Advantageously, the improved techniques improve the user experience by recommending meeting times that are based on individual attendee preferences.

One embodiment of the improved techniques is directed to a method of recommending a meeting time of a meeting. The method includes accessing a set of meeting logs to identify a set of previous meeting times. The method also includes performing a meeting time identification operation to identify a recommended meeting time based on the set of meeting logs. The method further includes providing an electronic message to a user, the electronic message communicating the recommended meeting time to the user.

Additionally, some embodiments are directed to an electronic apparatus constructed and arranged to recommend a meeting time of a meeting. The apparatus includes a network interface, memory and controlling circuitry coupled to the memory. The controlling circuitry is constructed and arranged to carry out a method of recommending a meeting time of a meeting.

Further, some embodiments are directed to a computer program product having a non-transitory, computer-readable storage medium which stores executable code, which when executed by a controlling circuitry, causes the controlling circuitry to carry out a method of recommending a meeting time of a meeting.

### BRIEF DESCRIPTION OF THE DRAWING

The foregoing and other objects, features and advantages will be apparent from the following description of particular embodiments of the invention, as illustrated in the accompanying figures in which like reference characters refer to the same parts throughout the different views.

FIG. 1 is a block diagram illustrating an example electronic environment in which the improved technique can be carried out.

FIG. 2 is a block diagram illustrating an example implementation of a meeting time identifier within the electronic environment illustrated in FIG. 1.

FIG. 3 is a block diagram illustrating an example implementation of a selection of a common meeting time within the electronic environment illustrated in FIG. 1.

FIG. 4 is a block diagram illustrating an example implementation of a selection of a movable meeting time within the electronic environment illustrated in FIG. 1.

FIG. 5 is a flow chart illustrating an example method of carrying out the improved technique within the electronic environment illustrated in FIG. 1.

### DETAILED DESCRIPTION

Improved techniques of finding a meeting time involve recommending a meeting time based on attendee meeting history. Advantageously, the improved techniques enable a meeting organizer to schedule a meeting automatically and with a greater chance of success compared with the conventional approaches.

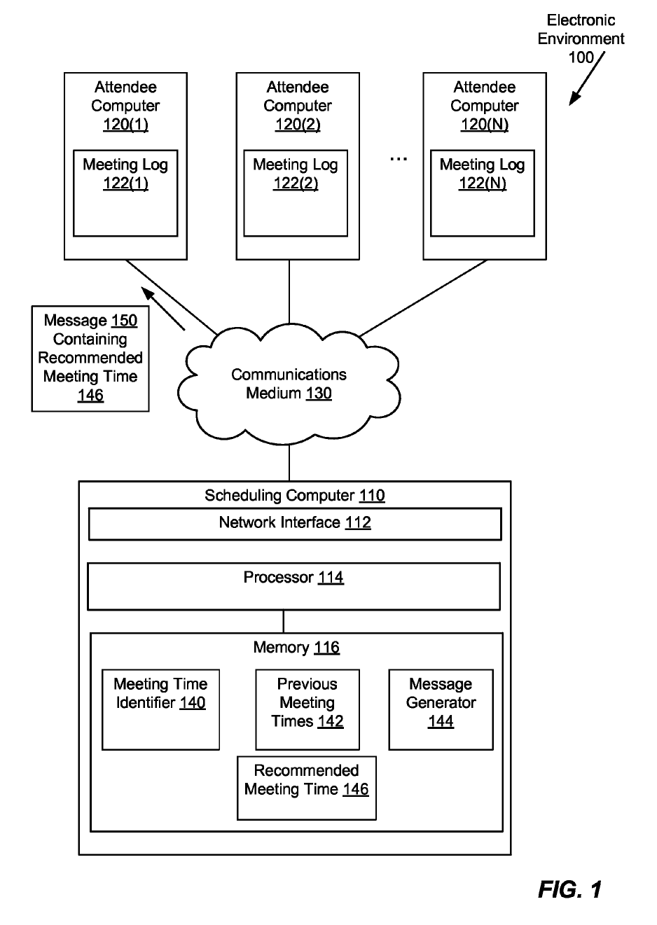

FIG. 1 shows an example electronic environment 100 in which embodiments of the improved techniques hereof can be practiced. The electronic environment 100 includes a scheduling computer 110, attendee computers 120(1), 120(2), . . . , 120(N), and a communications medium 130.

The scheduling computer 110 is configured to find a meeting time at which to hold a meeting according to the improved techniques. The scheduling computer 110 includes a network interface 112, a processor 114, and memory 116.

The network interface 112 includes, for example, adapters, such as SCSI target adapters and network interface adapters, for converting electronic and/or optical signals received from the communications medium 130 to electronic form for use by scheduling computer 110. The processor 114 includes one or more processing chips and/or assemblies. In a particular example, the processor 114 includes a multi-core CPU. The memory 116 includes both volatile memory (e.g., RAM), and non-volatile memory, such as one or more ROMs, disk drives, solid state drives, and the like. The processor 114 and the memory 116 together form control circuitry, which is constructed and arranged to carry out various functions as described herein.

The memory 116 also includes a variety of software constructs realized in the form of executable instructions, such as a meeting time identifier 140 and a message generator 144. When the executable instructions are run by the processor 114, the processor 114 is caused to carry out the operations of the software constructs. Although certain software constructs are specifically shown and described, it is understood that the memory 116 typically includes many other software constructs, which are not shown, such as an operating system, various applications, processes, and daemons, for example.

In addition, the memory 116 also stores data used in finding meeting times of meetings. As illustrated in FIG. 1, such data includes a set of previous meeting times 142 and a recommended meeting time 146.

Each attendee computer 120 is configured to run software that tracks meeting invitations and whether each invitation was accepted or rejected. The attendee computers 120 are typically desktop personal computers or laptops capable of accessing communications medium 130, but may also take the form of smartphones, tablets, and the like.

Communications medium 130 provides network connections between the scheduling computer 110 and the attendee computers 120(1), . . . , 120(N). Communications medium 130 may implement any of a variety of protocols and topologies that are in common use for communications over the Internet. Furthermore, communications medium 130 may include various components (e.g., cables, switches/routers, gateways/bridges, etc.) that are used in such communications.

During an example operation, a meeting organizer initiates a meeting. The meeting organizer does so by specifying a list of meeting attendees to attend a meeting and specifying a period of time during which a meeting may be held. In some arrangements, a meeting organizer may be an attendee of the meeting that is being scheduled. In this case, the scheduling computer 110 is also an attendee computer 120. In other arrangements, the meeting organizer may be a secretary to an attendee. Moreover, the attendees may be employees of a company or companies and their computers connected over communications medium 130.

After the meeting organizer initiates a meeting within scheduling computer 110 and specifies the attendees, the scheduling computer 110 accesses respective meeting logs 122(1), 122(2), . . . , 122(N) from each attendee computer 120(1), 120(2), . . . , 120(N). Each meeting log 122 contains information about previous meetings. For example, each meeting log 122 identifies times at which the respective attendee was invited to a meeting and whether that attendee accepted or rejected the meeting. In some arrangements, each meeting log 122 may contain other information including whether an attendee actually attended a meeting. Upon accessing the meeting logs 122(1), . . . 122(N) of each attendee, processor 114 stores previous meeting information 140 in memory 116.

When the meeting information 140 is stored in the memory 116, the meeting time identifier 142 causes the processor 114 to analyze the information 140 about the previous meetings of each attendee in light of the specified period of time during which the meeting may be held. In one example, the meeting attendees have multiple common times at which they may be able to attend the meeting. In this case, the processor 114 may then compute a likelihood of any attendee declining a meeting time proposed during one of the common times. In another example, the meeting attendees do not have any common times at which they may be able to attend the meeting. In this case, the processor 114 may then compute a likelihood of any attendee being able to free up time that is currently considered unavailable.

As a result of the analysis, the processor 114 stores a recommended meeting time 146 in memory 116. The recommended meeting time 146 may be a time at which the meeting attendees are most likely to accept the meeting invitation based on the information 140 about the previous meeting times.

Upon the recommended meeting time being stored in memory 116, the message generator 144 generates a message 150 that contains the recommended meeting time 146 and sends the message 150 to attendee computer 120.

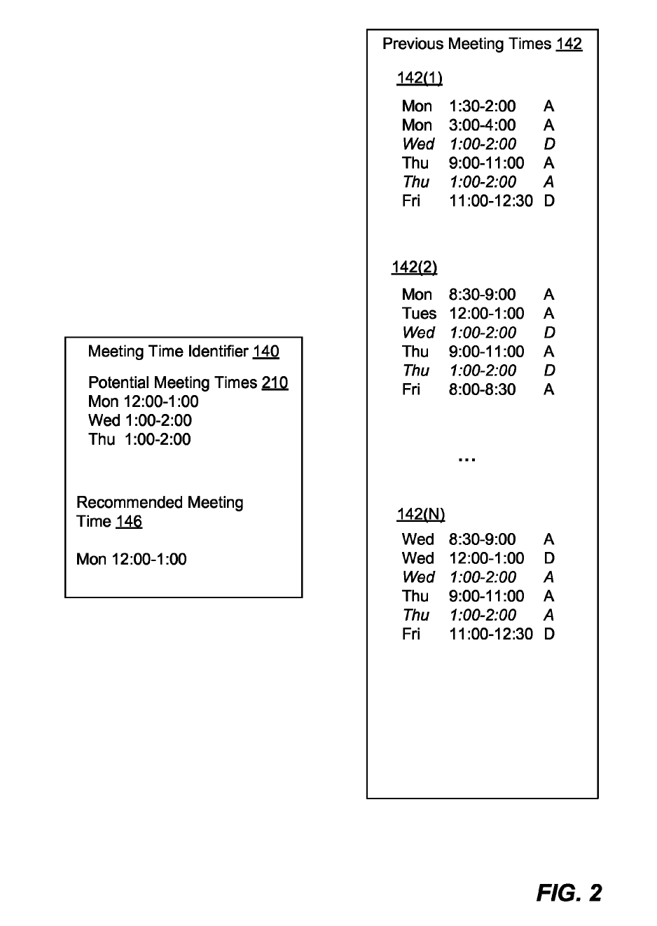

FIG. 2 illustrates further details of the meeting time identifier 140 and the previous meeting time information 142 on which the meeting time identifier 140 acts.

Meeting time identifier 140 acts on proposed meeting times 210, which are derived by the processor 114 in response to the meeting attendees being contacted. For example, the proposed meeting times 210 may simply be the common times at which each invitee is available during the specified period of time. However, the proposed meeting times may also include times at which the processor 114 has determined that an invitee may be likely to accept a meeting anyway even if listed as unavailable.

As illustrated in FIG. 2, the previous meeting time information 142 includes, for each attendee, a list of previous meeting times at which that attendee was invited to a meeting and a notation of whether that attendee accepted (“A”) or declined (“D”) that meeting invitation. Previous meeting times that overlap with the proposed meeting times are italicized in FIG. 2, as those previous meeting times are the ones typically considered in recommending a meeting time. However, in some arrangements, other previous meeting times (i.e., those not italicized in FIG. 2) may also be considered.

During an example operation, the processor 114 loops through each proposed meeting time. For each proposed meeting time, the processor 114 computes a likelihood that any attendee might decline an invitation to the meeting at that proposed meeting time. Such a likelihood is based on a history of each “A” or “D” associated with the previous meeting times that overlap that proposed meeting time.

It should be understood that the proposed meeting times are typically quantized in specified units of time, e.g., 30-minute intervals.

In some arrangements, the previous meeting time information 142 contains more detail that allows the processor 114 to perform accurate estimates of such likelihoods of attendees declining invitations. For example, the detail may revolve around a set of heuristic rules that may or may not be satisfied by each attendee's precious meeting history. Each such heuristic rule may be weighted according to their importance in determining a best meeting time for all attendees.

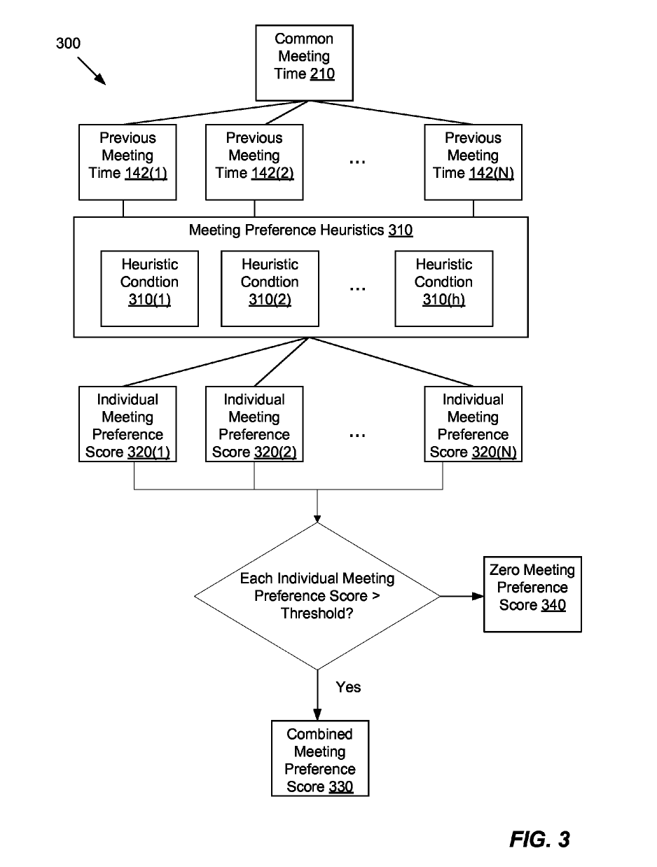

FIG. 3 illustrates an example process 300 of computing a likelihood of attendees declining an invitation to a meeting at a proposed time in the case of the attendees having multiple commonly available times. This process involves computing a meeting preference score 330 for a given proposed meeting time 210 based on a set of meeting preference heuristics 310.

It should be understood that the meeting preference score 330 is a combination of individual meeting preference scores 320 for each attendee. Then the set of meeting preference heuristics 310 are rules, or conditions, by which a meeting attendee's previous meeting history is scored with respect to a proposed meeting time 210. Examples of such meeting preference heuristics 310 include the following.

1) The time of day an attendee schedules meetings. If most the meetings scheduled by or on behalf of an attendee over a specified period of time, e.g., in the last month, are within a given time period, e.g., 1:00 PM and 3:00 PM on Mondays, the attendee's meeting preference score 320 with respect to the proposed time in that given time period, e.g., 1:00 PM-3:00 PM on Mondays, is increased.

2) The proposed meeting times an attendee accepts. If an attendee accepts most meetings over a specified period of time, e.g., in the last month, are within a given time period, e.g., 1:00 PM and 3:00 PM on Mondays, the attendee's meeting preference score 320 with respect to the proposed time in that given time period, e.g., 1:00 PM-3:00 PM on Mondays, is increased.

3) The proposed meeting times an attendee rejects or attempts to reschedule—one time meeting. If an attendee rejects or attempts to reschedule one-time meetings within a given time period, e.g., between 8:00-9:00 AM, the attendee's meeting preference score 320 with respect to the proposed time in that given time period, e.g., 8:00-9:00 AM, is decreased.

4) The proposed meeting times an attendee rejects or attempts to reschedule—recurring meeting. If an attendee rejects or attempts to reschedule recurring meetings within a given time period, e.g., between 8:00-9:00 AM, the attendee's meeting preference score 320 with respect to the proposed time in that given time period, e.g., 8:00-9:00 AM, is decreased.

It should be understood that there might not be enough previous meeting data 142 to increase or decrease an attendee's meeting preference score 320. For example, there might not be enough data to make a judgment about whether to increase or decrease a score 320 relative to a time slot of 1:00 PM-3:00 PM on Mondays. In that case, processor 114 might take an average of the 1:00 PM-3:00 PM time slots for the other days of the week.

Formally, the individual meeting preference score 320 (Pₖ) for an attendee at attendee computer 120(k) is given by the following expression:

$${P}_{k} = {\sum }_{i = 1}^{{h}_{p}} {W}_{i}^{( p )} {H}_{i}^{( p )} ,$$

where Hᵢ^{(p)} is a heuristic score for the ith heuristic 310(i). For example, processor 114 might set Hᵢ^{(p)}=+1 when an attendee at computer 120(i) is likely to accept a meeting in the proposed time slot 210 according to the ith heuristic 310(i) and Hᵢ^{(p)}=−1 when an attendee at computer 120(i) is likely to decline a meeting in the proposed time slot 210 according to the ith heuristic 310(i).

Wᵢ^{(p)} represents a weight corresponding to the ith heuristic 310(i), and indicates the importance of that heuristic 310(i) to the overall individual meeting preference score 320. Such weights may be based on feedback from actual acceptances and declines of the proposed meeting.

Once the processor 114 computes each individual preference score 320 of each attendee, the processor 114 computes the combined meeting preference score 330 (MPS) as follows:

$$MPS = {\sum }_{k = 1}^{N} {P}_{k} {\prod }_{j = 1}^{N} θ ( {P}_{j} - {T}_{p} ) ,$$

where Tₚ is a threshold score, and θ is the Heaviside step function:

$$θ ( x ) = \{ \begin{matrix}0 , & x < 0 \\ 1 , & x \geq 0\end{matrix} .$$

The combined meeting preference score 330 is therefore only nonzero when each individual threshold score 320 is larger than some specified threshold. A reason why the score 330 is set to zero in such cases is so that highly undesirable time slots for a particular attendee do not get hidden within desirable time slots for other attendees. However, it should be understood that there are other ways of avoiding such disparities in results, e.g., penalizing time slots having a large variance of individual scores 320.

The processor 114 computes the combined meeting preference score 330 for each proposed meeting time 210. The processor 114 then chooses the proposed meeting time 210 having the largest combined meeting preference score 330.

In some arrangements, the processor initially finds no common available times from which to propose meeting times. In this case, the processor 114 uses the previous meeting information 142 in order to find times labeled as “unavailable” at which an attendee is likely to accept a proposed meeting anyway.

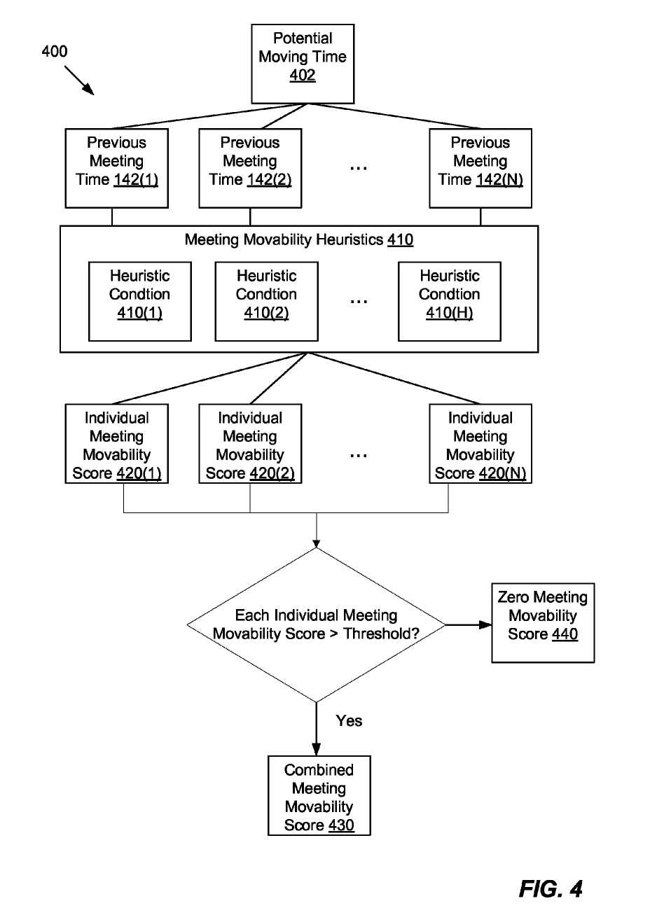

FIG. 4 illustrates an example process 400 of computing a likelihood of attendees accepting an invitation to a meeting at a proposed time in the case of the attendees having no commonly available times. This process involves computing a meeting movability score 430 for a given potential moving time 402 based on a set of meeting movability heuristics 410.

It should be understood that the meeting movability score 430 is a combination of individual meeting movability scores 420 for each attendee. Then the set of meeting movability heuristics 410 are rules, or conditions, by which a meeting attendee's previous meeting history is scored with respect to a potential moving time 402. Examples of such meeting movability heuristics 410 include the following.

1) Keyword match for declined or rescheduled meetings. The processor 114 locates keywords for previous meetings that have been rescheduled or declined. If there are any such meetings on a calendar blocking time, we increase the individual meeting movability score 420 for that time assuming they might be able to skip that meeting for the potential moving time 402.

2) Online meetings attended or no show based on keyword match. Many meetings are online where attendees meet at a predetermined virtual online meeting space. An invite for online meeting in most cases has an online meeting web link. The processor 114 can track (subject to user permission) whether invitees clicked on the link at the meeting time. The click or lack thereof indicates whether an invitee attended a meeting or skipped it. The processor 114 may then match keywords in a meeting subject to find correlations with existing meetings on the invitee's calendar. Assuming meetings with similar subjects are considered low priority for the invitee and the time reserved for those meetings can be freed up for the proposed meeting, the individual meeting movability score 420 for the potential moving time 402 is increased.

3) Online meetings attended or no show based on list of invitees. Tracking user attendance for online meetings may also indicate whether an invitee usually skips meetings that have certain people in the invitee list. For example, there may be a two person team that takes turns attending meetings. If the processor 114 finds meetings inviting both members of such a team to a meeting, the processor 114 finds the time of that meeting and increases the individual meeting movability score 420 for the potential moving time 402.

4) Online meetings attended or no show based on job title. Teams that report to a meeting organizer might reschedule the meetings they are planning to attend with their peers or their direct reports. If the processor 114 finds meetings inviting members of such a team to a meeting, the processor 114 finds the time of that meeting and increases the individual meeting movability score 420 for the potential moving time 402.

5) Recurring vs. One-Time meetings. A one-time meeting might have a likelihood of being prioritized over a recurring meeting. If the processor 114 finds recurring meetings within the date and time range proposed, the processor 114 finds the time of that meeting and increases the individual meeting movability score 420 for the potential moving time 402.

6) Organizer vs. Invitee. An organizer is better equipped to move a meeting than an invitee. Then the processor increases the individual meeting movability score 420 of an organizer.

7) Number of invitees. The processor increases or decreases the individual meeting movability score 420 according to the number of people attending a meeting at the potential moving time 402.

Formally, the individual meeting movability score 420 (Mₖ) for an attendee at attendee computer 120(k) is given by the following expression:

$${M}_{k} = {\sum }_{i = 1}^{{h}_{m}} {W}_{i}^{( m )} {H}_{i}^{( m )} ,$$

where Hᵢ^{(m)} is a heuristic score for the ith heuristic 410(i). For example, processor 114 might set Hᵢ^{(m)}=+1 when an attendee at computer 120(i) is likely to be able to move a meeting for the potential moving time 402 and Hᵢ^{(m)}=−1 when an attendee at computer 120(i) is not likely to be able to move a meeting for the potential moving time 402.

Wᵢ^{(m)} represents a weight corresponding to the ith heuristic 410(i), and indicates the importance of that heuristic 410(i) to the overall individual meeting preference score 420. Such weights may be based on feedback from actual acceptances and declines of moves of meetings at the potential moving time 402.

Once the processor 114 computes each individual movability score 420 of each attendee, the processor 114 computes the combined meeting movability score 430 (MMS) as follows:

$$MMS = {\sum }_{k = 1}^{N} {M}_{k} {\prod }_{j = 1}^{N} θ ( {M}_{j} - {T}_{m} ) ,$$

where Tₘ is a threshold score, and θ is again the Heaviside step function:

$$θ ( x ) = \{ \begin{matrix}0 , & x < 0 \\ 1 , & x \geq 0\end{matrix} .$$

The combined meeting preference score 430 is therefore only nonzero when each individual threshold score 420 is larger than some specified threshold. A reason why the score 420 is set to zero in such cases is so that highly unmovable time slots for a particular attendee do not get hidden within movable time slots for other attendees. However, it should be understood that there are other ways of avoiding such disparities in results, e.g., penalizing time slots having a large variance of individual scores 420.

The processor 114 computes the combined meeting movability score 430 for each potential moving time 402. The processor 114 then chooses as a proposed meeting time 210 the potential moving time 402 having the largest combined meeting movability score 430.

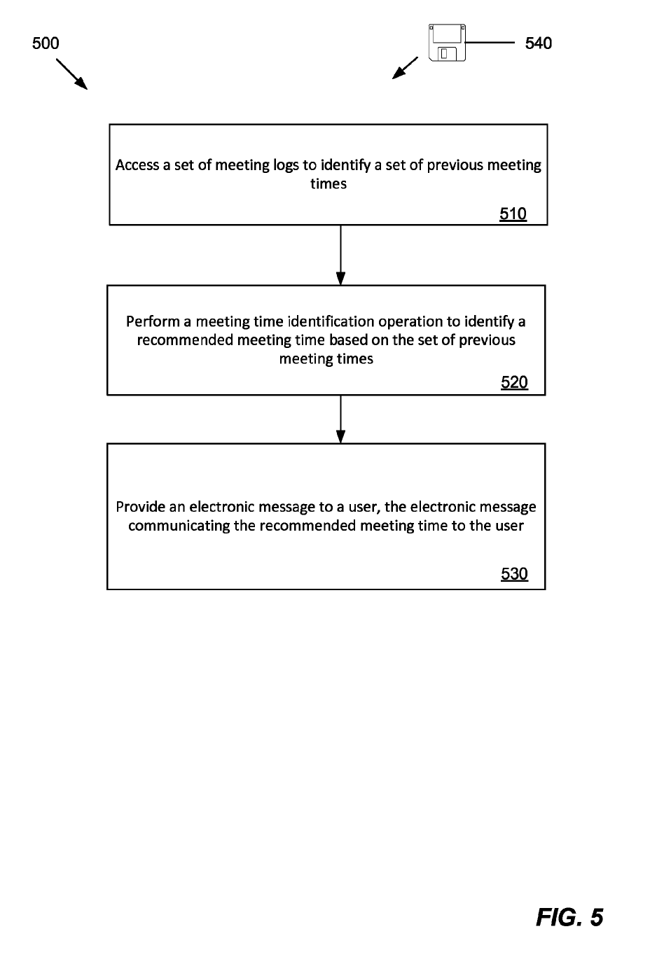

FIG. 5 illustrates a method 500 of recommending a meeting time of a meeting. The method 500 may be performed by the software constructs described in connection with FIGS. 1-4, which reside in the memory 116 of the scheduling computer 110 and are run by the processor 114.

At 510, a set of meeting logs is accessed to identify a set of previous meeting times. For example, each attendee computer 120 maintains a log of previous meeting times, as well as whether an attendee accepted or declined a meeting and even whether the attendee attended an online meeting.

At 520, a meeting time identification operation is performed to identify a recommended meeting time based on the set of meeting logs. For example, if there are multiple time slots during which all attendees may attend a meeting, the processor 114 may compute a meeting preference score according to process 300 to determine which of the time slots is best for the attendees.

At 530, an electronic message is provided to a user. The electronic message communicates the recommended meeting time to the user.

Improved techniques of finding a meeting time involve recommending a meeting time based on attendee meeting history. Advantageously, the improved techniques enable a meeting organizer to schedule a meeting automatically and with a greater chance of success compared with the conventional approaches.

It should be understood that the improved techniques described herein are directed to the improvement of a technological process, namely the automatic determination of a meeting time from meeting logs of attendees.

Having described certain embodiments, numerous alternate embodiments or variations can be made. For example, as discussed above, the meeting preference score and meeting movability score may each be based on statistical variance considerations rather than specified thresholds.

Also, it should be understood that, in a cloud context, some electronic circuitry is formed by remote computer resources distributed over a network. Such a computerized environment is capable of providing certain advantages such as distribution of hosted services and resources (e.g., software as a service, platform as a service, infrastructure as a service, etc.), enhanced scalability, etc. For example, each attendee computer 120(1), 120(2), . . . , 120(N) may store its respective meeting log 122(1), . . . 122(N) on a server in the cloud.

Further, although features are shown and described with reference to particular embodiments hereof, such features may be included and hereby are included in any of the disclosed embodiments and their variants. Thus, it is understood that features disclosed in connection with any embodiment are included as variants of any other embodiment.

Further still, the improvement or portions thereof may be embodied as a non-transient computer-readable storage medium, such as a magnetic disk, magnetic tape, compact disk, DVD, optical disk, flash memory, Application Specific Integrated Circuit (ASIC), Field Programmable Gate Array (FPGA), and the like (shown by way of example as medium 440 in FIG. 4). Multiple computer-readable media may be used. The medium (or media) may be encoded with instructions which, when executed on one or more computers or other processors, perform methods that implement the various processes described herein. Such medium (or media) may be considered an article of manufacture or a machine, and may be transportable from one machine to another.

As used throughout this document, the words “comprising,” “including,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Although certain embodiments are disclosed herein, it is understood that these are provided by way of example only and the invention is not limited to these particular embodiments.

Those skilled in the art will therefore understand that various changes in form and detail may be made to the embodiments disclosed herein without departing from the scope of the invention.

What is claimed is:

1. A method of recommending a meeting time of a meeting, the method comprising:
accessing a set of meeting logs to identify a set of previous meeting times;
performing a meeting time identification operation to identify a recommended meeting time based on the set of previous meeting times;
providing an electronic message to a user, the electronic message communicating the recommended meeting time to the user.

2. A method as in claim 1 wherein the user is an organizer of a meeting having meeting attendees;
wherein accessing the set of meeting logs includes obtaining, for each of the attendees, previous meeting times of that attendee; and
wherein performing the meeting time identification operation includes:
generating a potential meeting time for the meeting;
for each of the attendees,
finding an overlapping previous meeting time of that attendee, the overlapping previous meeting time overlapping the potential meeting time, and
evaluating whether that attendee accepted an invitation to a previous meeting scheduled at the overlapping previous meeting time to produce a previous meeting attendance indicator of that attendee; and
selecting the potential meeting time as the recommended meeting time based on the previous meeting attendance indicator of each of the attendees.

3. A method as in claim 2, wherein generating the potential meeting time includes producing multiple common times during which the attendees are available for the meeting; and
wherein selecting the potential meeting time as the recommended meeting time includes:
for each common time,
for each attendee, generating an individual meeting preference score based on the previous meeting attendance indicator of that attendee, the individual meeting preference score indicating a likelihood of that attendee attending the meeting at that common time, and
combining the individual meeting preference score of each of the attendees to produce a combined meeting preference score of that common time; and
identifying, as the recommended meeting time, a particular common time, the combined meeting preference score of the particular common time being greater than or equal to the combined meeting preference score of each of the common times.

4. A method as in claim 3, wherein combining the individual meeting preference score of each of the attendees includes:
for a first common time in which the individual meeting preference score of each of the attendees is greater than a threshold, summing the individual meeting preference score of each of the attendees to produce the combined meeting preference score of the first common time; and
for a second common time in which the individual meeting preference score of an attendee is less than the threshold, setting the combined meeting preference score of the second common time equal to zero.

5. A method as in claim 3, wherein generating the individual meeting preference score includes, for each of the attendees:
for each of a set of heuristics, evaluating whether that attendee satisfies a condition defined by that heuristic to produce a heuristic value of that heuristic for that attendee; and
combining the heuristic value of each of the set of heuristics to produce the individual meeting preference score of that attendee.

6. A method as in claim 5, wherein combining the heuristic value of each of the set of heuristics includes:
receiving a respective weight value corresponding to each of the set of heuristics, a respective weight value indicating an importance of the heuristic to which it corresponds in selecting the recommended meeting time; and
summing a product of the heuristic value of each of the set of heuristics and the respective weight value corresponding to each of the set of heuristics.

7. A method as in claim 5, wherein a condition defined by a heuristic of the set of heuristics includes, for an attendee, a number of invitations for previous meetings at a previous meeting time having been accepted by the attendee being at least a threshold fraction of the number of invitations sent to the attendee;
wherein evaluating whether each of the attendees satisfies the condition defined by the heuristic includes, for the attendee:
computing a ratio of the number of invitations for previous meetings at a previous meeting time having been accepted by the attendee to the number of invitations sent to the attendee; and
comparing the ratio to the threshold fraction.

8. A method as in claim 2, wherein there are no common times during which the attendees are available for a meeting;
wherein generating the potential meeting time includes:
identifying a set of movable times at which attendees have been invited to attend other meetings; and
moving at least one other meeting to another time to make the attendees available at the identified set of movable times.

9. A method as in claim 8, wherein multiple movable times during which the attendees are available for a meeting are identified; and
wherein selecting the potential meeting time as the recommended meeting time includes:
for each movable time,
for each attendee, generating an individual meeting movability score based on the previous meeting attendance indicator of that attendee, the individual meeting movability score indicating a likelihood of that attendee moving other meetings scheduled at that movable time, and
combining the individual meeting movability score of each of the attendees to produce a combined meeting movability score of that movable time; and
identifying, as the recommended meeting time, a particular movable time, the combined meeting movability score of the particular movable time being greater than or equal to the combined meeting movability score of each of the movable times.

10. A method as in claim 9, wherein combining the individual meeting movability score of each of the attendees includes:
for a first movable time in which the individual meeting movability score of each of the attendees is greater than a threshold, summing the individual meeting movability score of each of the attendees to produce the combined meeting movability score of the first movable time; and
for a second movable time in which the individual meeting movability score of an attendee is less than the threshold, setting the combined meeting movability score of the second movable time equal to zero.

11. A method as in claim 9, wherein generating the individual meeting movability score includes, for each of the set of attendees:
for each of a set of heuristics, evaluating whether that attendee satisfies a condition defined by that heuristic to produce a heuristic value of that heuristic for that attendee; and
combining the heuristic value of each of the set of heuristics to produce the individual meeting movability score of that attendee.

12. A method as in claim 11, wherein combining the heuristic value of each of the set of heuristics includes:
receiving a respective weight value corresponding to that heuristic, the respective weight value indicating an importance of each of the set of heuristics in selecting the recommended meeting time; and
summing a product of the heuristic value of each of the set of heuristics and the respective weight value corresponding to each of the set of heuristics.

13. A method as in claim 11, wherein a condition defined by a heuristic of the set of heuristics includes, for an attendee, a matching of a keyword used in declining a meeting; and
evaluating whether each of the attendees satisfies a condition defined by a heuristic includes, for the attendee, searching the set of meeting logs for the presence of the keyword.

14. A computer program product including a non-transitory, computer-readable storage medium which stores executable code, which when executed by a computer, causes the computer to perform a method of recommending a meeting time of a meeting, the method comprising:
accessing a set of meeting logs to identify a set of previous meeting times;
performing a meeting time identification operation to identify a recommended meeting time based on the set of previous meeting times;
providing an electronic message to a user, the electronic message communicating the recommended meeting time to the user.

15. A computer program product as in claim 14 wherein the user is an organizer of a meeting having meeting attendees;
wherein accessing the set of meeting logs includes obtaining, for each of the attendees, previous meeting times of that attendee; and
wherein performing the meeting time identification operation includes:
generating a potential meeting time for the meeting;
for each of the attendees,
finding an overlapping previous meeting time of that attendee, the overlapping previous meeting time overlapping the potential meeting time, and
evaluating whether that attendee accepted an invitation to a previous meeting scheduled at the overlapping previous meeting time to produce a previous meeting attendance indicator of that attendee; and
selecting the potential meeting time as the recommended meeting time based on the previous meeting attendance indicator of each of the attendees.

16. A computer program product as in claim 15, wherein generating the potential meeting time includes producing multiple common times during which the attendees are available for the meeting; and
wherein selecting the potential meeting time as the recommended meeting time includes:
for each common time,
for each attendee, generating an individual meeting preference score based on the previous meeting attendance indicator of that attendee, the individual meeting preference score indicating a likelihood of that attendee attending the meeting at that common time, and
combining the individual meeting preference score of each of the attendees to produce a combined meeting preference score of that common time; and
identifying, as the recommended meeting time, a particular common time, the combined meeting preference score of the particular common time being greater than or equal to the combined meeting preference score of each of the common times.

17. A computer program product as in claim 16, wherein combining the individual meeting preference score of each of the attendees includes:
for a first common time in which the individual meeting preference score of each of the attendees is greater than a threshold, summing the individual meeting preference score of each of the attendees to produce the combined meeting preference score of the first common time; and
for a second common time in which the individual meeting preference score of an attendee is less than the threshold, setting the combined meeting preference score of the second common time equal to zero.

18. A computer program product as in claim 16, wherein generating the individual meeting preference score includes, for each of the attendees:
for each of a set of heuristics, evaluating whether that attendee satisfies a condition defined by that heuristic to produce a heuristic value of that heuristic for that attendee; and
combining the heuristic value of each of the set of heuristics to produce the individual meeting preference score of that attendee.

19. A computer program product as in claim 18, wherein combining the heuristic value of each of the set of heuristics includes:
receiving a respective weight value corresponding to each of the set of heuristics, a respective weight value indicating an importance of the heuristic to which it corresponds in selecting the recommended meeting time; and
summing a product of the heuristic value of each of the set of heuristics and the respective weight value corresponding to each of the set of heuristics.

20. An electronic apparatus constructed and arranged to recommend a meeting time of a meeting, the apparatus comprising:
a network interface;
memory; and
controlling circuitry coupled to the memory, the controlling circuitry being constructed and arranged to:
access a set of meeting logs to identify a set of previous meeting times;
perform a meeting time identification operation to identify a recommended meeting time based on the set of previous meeting times;
provide an electronic message to a user, the electronic message communicating the recommended meeting time to the user.
